(19) United States
(12) Patent Application Publication
(10) Pub. No.: US 2015/0124902 A1
(43) Pub. Date: May 7, 2015

(54) TRANSMITTING DEVICE, RECEIVING DEVICE, TRANSMITTING METHOD, PROGRAM, AND INTEGRATED CIRCUIT

(71) Applicant: SHARP KABUSHIKI KAISHA, Osaka-shi, Osaka (JP)

(72) Inventors: Jungo Goto, Osaka-shi (JP); Hiroki Takahashi, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/400,280

(22) PCT Filed: May 10, 2013
(86) PCT No.: PCT/JP2013/063152

§ 371 Date: Nov. 10, 2014

(30) Foreign Application Priority Data
May 11, 2012 (JP) 2012-109696

(51) Int. Cl. H04L 27/26

(52) U.S. Cl. CPC H04L 27/2627
USPC 375/295

(57) ABSTRACT

When signals to be transmitted to a plurality of mobile station devices are multiplexed by hierarchical modulation in a downlink, an increase in difference in reception quality among the mobile station devices is prevented. A transmitting device of the present invention is a transmitting device which performs data transmission to a plurality of receiving devices by using a plurality of symbols and a plurality of layers with different distances between signal points, and includes a modulating unit 118-n which assigns data to be transmitted to a first receiving device to a first layer in a predetermined symbol of the plurality of symbols and assigns data to be transmitted to a second receiving device different from the first receiving device to the first layer in remaining symbols and a transmission processing unit 127 which transmits each data assigned to the first layer to the first receiving device and the second receiving device.

### TECHNICAL FIELD

The present invention relates to technology of transmitting data from a base station device to a plurality of mobile station devices.

### BACKGROUND ART

In a mobile communication system, the system band has been widened due to an upsurge in traffic, and an improvement in spectral efficiency is an issue because frequencies are a limited resource. In communication between a base station device and a plurality of mobile station device, an access scheme is generally used in which orthogonality among the mobile station devices is kept to prevent interference (also referred to as inter user interference) among the mobile station devices, and standardization has been made in recent years on the premise of frequency division multiple access (FDMA), which is an access scheme for keeping orthogonality. In FDMA, frequency scheduling and orthogonality can be both achieved. Note that other than orthogonalization by FDMA, means for achieving orthogonalization among the mobile station devices include orthogonalization such as time division multiple access (TDMA), code division multiple access (CDMA), and space division multiple access (SDMA, which is also referred to as multiuser multiple-input multiple-output (MIMO)).

For example, in Rel. 8 of The Third Generation Partnership Project (3GPP), which is a standardization organization, orthogonal frequency division multiplexing (OFDM) is used in a downlink (communication from the base station device to the mobile station device), and discrete Fourier transform spread OFDM (DFT-S-OFDM) is used in an uplink (communication from the mobile station device to the base station device) as a transmission scheme with a high affinity with FDMA. Furthermore, also in Rel. 10, in addition to these access schemes, clustered DFT-S-OFDM or N×DFT-S-OFDM is used in an uplink. While these adopted access schemes are approaches to achieve large-capacity transmission based on FDMA, keeping orthogonality is restrictive in view of an improvement in spectral efficiency. Therefore, a non-orthogonal access scheme which eliminates restrictions of orthogonality has been suggested, and the non-orthogonal access scheme can improve spectral efficiency more than the orthogonal access scheme (refer to NPL 1).

As a next-generation access scheme for a downlink, non-orthogonal access schemes such as superposition coding and hierarchical modulation have been considered (refer to NPLs 2 and 3). When the base station device multiplexes signals of the plurality of mobile station devices by hierarchical modulation for transmission, assignment is performed to a layer with a short distance between signal points in the mobile station device positioned at the cell center (mobile station device with high power of a signal received from the base station device) and assignment is performed to a layer with a long distance between signal points in the mobile station device positioned at a cell edge (mobile station device with low power of the signal received from the base station device). When the mobile station device positioned at the cell edge performs signal detection, since assignment is made to a layer with the long distance between signal points, signal detection is performed irrespectively of multiplexed signals of other mobile station devices. Signal detection at the mobile station device positioned at the cell center has a short distance between signal points but reception power of the signal from the base station device is high. Therefore, signal detection by a successive interference canceller (SIC) or MLD is performed. In this case, the signal of the mobile station device positioned at the cell edge is first detected and cancelled from the reception signal, and then a desired signal is detected.

### CITATION LIST

### Non Patent Literature

NPL 1: P. Wang, J. Xiao, L. Ping, “Comparison of orthogonal and non-orthogonal approaches to future wireless cellular systems”, IEEE Vehicular Technology Magazine, Vol. 1, no. 3, pp. 4-11, September 2006.
NPL 2: Qualcomm, R1-050902, “Description and Simulations of Hierarchical Modulation Technique for E-UTRA MBMS Evaluation”
NPL 3: Fujitsu, R1-083776, “An Efficient Hierarchical Modulation based DL Data Transmission for LTE-Advanced”

### SUMMARY OF INVENTION

### Technical Problem

However, as in the above-described conventional art, when the layers are fixed in a manner such that signals to be transmitted to the mobile station device positioned at the cell center are all assigned to a layer with a short distance between signal points and signals to be transmitted to the mobile station device positioned at the cell edge are all assigned to a layer with a long distance between signal points, inconveniences occur as follows. That is, when a difference in reception power of the signals received from the base station is small among the mobile station devices for multiplexing by hierarchical modulation, a mobile station device assigned to a layer with a short distance between signal points has an extremely high possibility of error occurrence, compared with a mobile station device with signals assigned to a layer with a long distance between signal points. As a result, there is a problem in which a difference in reception quality among the mobile station devices is increased.

The present invention has been made in view of these circumstances, and has an object of providing a transmitting device, receiving device, transmitting method, program, and integrated circuit capable of preventing, when signals to be transmitted to a plurality of mobile station devices are multiplexed by hierarchical modulation in a downlink, an increase in difference in reception quality among the mobile station devices.

### Solution to Problem

(1) To achieve the object described above, the present invention takes measures as follows. That is, a transmitting device of the present invention is a transmitting device which performs data transmission to a plurality of receiving devices by using a plurality of symbols and a plurality of layers with different distances between signal points and includes a layer assigning unit which assigns data to be transmitted to a first receiving device to a first layer in a predetermined symbol of the plurality of symbols and assigns data to be transmitted to a second receiving device different from the first receiving device to the first layer in remaining symbols and a transmitting unit which transmits each of the data assigned to the first layer to the first receiving device and the second receiving device.

As such, the data to be transmitted to the first receiving device is assigned to the first layer in the predetermined symbol of the plurality of symbols and the data to be transmitted to the second receiving device different from the first receiving device is assigned to the first layer in remaining symbols. Therefore, unevenness of reception quality among the receiving devices can be avoided. As a result, the receiving device assigned to only the layer with a short distance between signals is not present, and an improvement in cell throughput and spectral efficiency can be achieved.

(2) Also, in the transmitting device of the present invention, the layer assigning unit assigns the data to be transmitted to the first receiving device to the first layer in the predetermined symbol of the plurality of symbols and assigns the data to be transmitted to the second receiving device to a second layer different from the first layer, and the transmitting unit transmits the data assigned to the first layer to the first receiving device and transmits the data assigned to the second layer to the second receiving device.

As such, the data to be transmitted to the first receiving device is assigned to the first layer in the predetermined symbol of the plurality of symbols and the data to be transmitted to the second receiving device is assigned to the second layer different from the first layer. Therefore, when signals are multiplexed by hierarchical modulation, unevenness of reception quality among the receiving devices can be avoided. As a result, the receiving device assigned to only the layer with a short distance between signals is not present, and an improvement in cell throughput and spectral efficiency can be achieved.

(3) Furthermore, in the transmitting device of the present invention, the layer assigning unit determines the predetermined symbol based on a table or a definition equation configured in advance.

As such, the predetermined symbol is determined based on a table or a definition equation configured in advance. Therefore, the predetermined symbol can be determined without using control information. As a result, an improvement in cell throughput can be achieved.

(4) Still further, in the transmitting device of the present invention, the layer assigning unit sets a number of predetermined symbols at an integer closest to M/N, where N is a positive integer representing a number of the layers and M is a positive integer representing a number of the plurality of symbols.

As such, the number of predetermined symbols is set at an integer closest to M/N, where N is a positive integer representing the number of the layers and M is a positive integer representing the number of the plurality of symbols. Therefore, the predetermined symbol can be determined without using control information. As a result, an improvement in throughput can be achieved.

(5) Still further, in the transmitting device of the present invention, the layer assigning unit determines a number of the predetermined symbols in accordance with reception quality.

As such, the number of the predetermined symbols is determined in accordance with reception quality. Therefore, the transmission performance can be made uniform among transmitting devices with different degrees of reception quality. As a result, an improvement in throughput can be achieved.

(6) Still further, in the transmitting device of the present invention, a coding rate is determined in accordance with the number of the predetermined symbols.

As such, the coding rate is determined in accordance with the number of the predetermined symbols. Therefore, signals assigned to the plurality of layers can be easily detected, and a degradation in error rate can be avoided.

(7) Still further, in the transmitting device of the present invention, the first layer is a layer with most favorable error rate performance.

As such, the first layer is a layer with most favorable error rate performance. Therefore, unevenness in reception quality among the receiving devices can be avoided, and an improvement in cell throughput and spectral efficiency can be achieved.

(8) Still further, the transmitting device of the present invention is the transmitting device according to (1) or (2) described above which assigns the plurality of symbols to a sub-carrier configuring an orthogonal frequency division multiplexing (OFDM) signal, wherein the layer assigning unit assigns the data to be transmitted to the first receiving device to the first layer in a predetermined OFDM symbol and assigns the data to a layer different from the first layer in another OFDM symbol.

As such, the data to be transmitted to the first receiving device is assigned to the first layer in the predetermined OFDM symbol and the data is assigned to the layer different from the first layer in another OFDM symbol. Therefore, unevenness in reception quality among the receiving devices can be avoided in the OFDM system, and an improvement in cell throughput and spectral efficiency can be achieved.

(9) Still further, a receiving device of the present invention is a receiving device which receives data transmitted from the transmitting device according to (1) described above by using a plurality of symbols and a plurality of layers with different distances between signal points, and the receiving device includes a layer demodulating unit which demodulates data assigned to the plurality of layers for each of the layers, and an extracting unit which extracts the data from the signal demodulated for each of the layers.

With this structure, unevenness of reception quality can be avoided.

(10) Also, a transmitting method of the present invention is a transmitting method for performing data transmission to a plurality of receiving devices by using a plurality of symbols and a plurality of layers with different distances between signal points, and the method includes at least a step of assigning data to be transmitted to a first receiving device to a first layer in a predetermined symbol of the plurality of symbols and assigning data to be transmitted to a second receiving device different from the first receiving device to the first layer in remaining symbols and a step of transmitting each of the data assigned to the first layer to the first receiving device and the second receiving device.

As such, the data to be transmitted to the first receiving device is assigned to the first layer in the predetermined symbol of the plurality of symbols and the data to be transmitted to the second receiving device different from the first receiving device is assigned to the first layer in remaining symbols. Therefore, unevenness of reception quality among the receiving devices can be avoided. As a result, the receiving device assigned to only the layer with a short distance between signals is not present, and an improvement in cell throughput and spectral efficiency can be achieved.

(11) Also, a program of the present invention is a program for a transmitting device which performs data transmission to a plurality of receiving devices by using a plurality of symbols and a plurality of layers with different distances between signal points, and the program causes a computer to perform a series of processes including a process of assigning data to be transmitted to a first receiving device to a first layer in a predetermined symbol of the plurality of symbols and assigning data to be transmitted to a second receiving device different from the first receiving device to the first layer in remaining symbols, and a process of transmitting each of the data assigned to the first layer to the first receiving device and the second receiving device.

As such, the data to be transmitted to the first receiving device is assigned to the first layer in the predetermined symbol of the plurality of symbols and the data to be transmitted to the second receiving device different from the first receiving device is assigned to the first layer in remaining symbols. Therefore, unevenness of reception quality among the receiving devices can be avoided. As a result, the receiving device assigned to only the layer with a short distance between signals is not present, and an improvement in cell throughput and spectral efficiency can be achieved.

(12) Also, an integrated circuit of the present invention is an integrated circuit mounted on a transmitting device to cause the transmitting device to achieve a plurality of functions, and the integrated circuit causes the transmitting device to achieve a series of functions including a function of performing data transmission to a plurality of receiving devices by using a plurality of symbols and a plurality of layers with different distances between signal points, a function of assigning data to be transmitted to a first receiving device to a first layer in a predetermined symbol of the plurality of symbols and assigning data to be transmitted to a second receiving device different from the first receiving device to the first layer in remaining symbols, and a function of transmitting each of the data assigned to the first layer to the first receiving device and the second receiving device.

As such, the data to be transmitted to the first receiving device is assigned to the first layer in the predetermined symbol of the plurality of symbols and the data to be transmitted to the second receiving device different from the first receiving device is assigned to the first layer in remaining symbols. Therefore, unevenness of reception quality among the receiving devices can be avoided. As a result, the receiving device assigned to only the layer with a short distance between signals is not present, and an improvement in cell throughput and spectral efficiency can be achieved.

### Advantageous Effects of Invention

According to the present invention, when signals to be transmitted to a plurality of mobile station devices are multiplexed by hierarchical modulation in a downlink, cell throughput can be improved, and an improvement in spectral efficiency can be achieved.

### BRIEF DESCRIPTION OF DRAWINGS

FIG. 1 is a schematic diagram depicting a communication system according to a first embodiment of the present invention.

FIG. 2 is a schematic block diagram depicting an example of a base station device eNB3 according to the first embodiment of the present invention.

FIG. 3 is a flowchart depicting an example of a method of determining a transmission scheme, a modulation scheme, a coding rate, and so forth.

FIG. 4 is a flowchart depicting a signal process at a transmission scheme selecting unit 115 according to the first embodiment of the present invention.

FIG. 5 is a block diagram depicting the structure of a modulating unit 118-i (1≦i≦n) according to the first embodiment of the present invention.

FIG. 6 is a diagram depicting an example of a layer assignment selecting method when signals of a mobile station device p and a mobile station device q according to the first embodiment of the present invention are multiplexed by a non-orthogonal access scheme.

FIG. 7 is a diagram depicting first layer assignment according to the first embodiment of the present invention.

FIG. 8 is a diagram depicting a modulation method to be performed by a second layer assigning unit 207 according to the first embodiment of the present invention.

FIG. 9 is a block diagram depicting an example of structure of a mobile station device, which is a receiving device having one receive antenna in the first embodiment of the present invention.

FIG. 10 is block diagram depicting an example of structure of a signal detecting unit 313 according to the first embodiment of the present invention.

FIG. 11 is a block diagram of another example of structure of the signal detecting unit 313 according to the first embodiment of the present invention.

FIG. 12 is a block diagram depicting an example of structure of a replica generating unit 503 according to the first embodiment of the present invention.

FIG. 13 is a flowchart depicting an example of a process at a transmission method determining unit 109 according to a second embodiment of the present invention.

FIG. 14 is a block diagram depicting an example of structure of the modulating units 118-1 to 118-n according to the second embodiment of the present invention.

FIG. 15 is a block diagram depicting an example of structure of the signal detecting unit 313 according to the second embodiment of the present invention.

### DESCRIPTION OF EMBODIMENTS

In the following, embodiments of the present invention are described with reference to the drawings. In the following embodiments, a downlink of transmission with a transmitting device performing data transmission taken as a base station device (e-NodeB) and a receiving device receiving data taken as a mobile station device (user device; UE) is described. Also, data transmitted from the base station device may be received not by the mobile station device but by a relay station device.

### First Embodiment

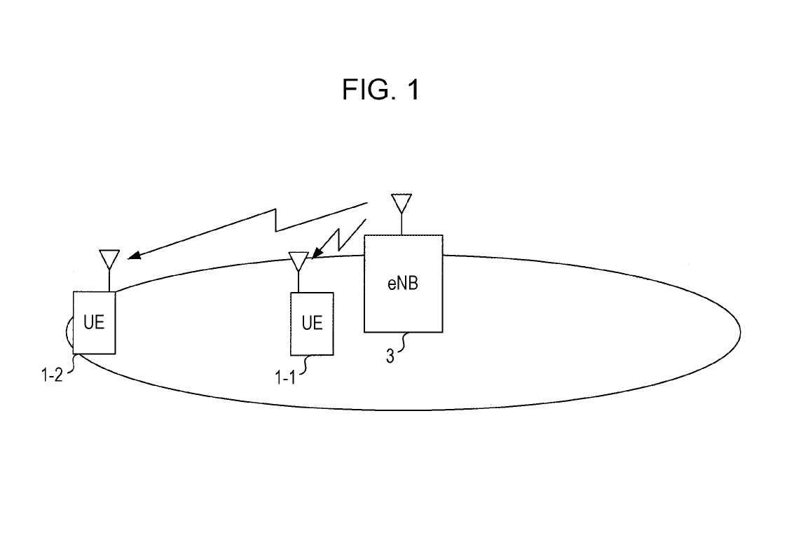

FIG. 1 is a schematic diagram depicting a communication system according to a first embodiment of the present invention. In this drawing, the communication system includes mobile station devices UE1-1 and UE1-2 (the mobile station devices UE1-1 and UE1-2 are hereinafter also collectively represented as a mobile station device UE1 or mobile station device 1) and a base station device eNB3 (hereinafter also represented as a base station device 3). When performing data transmission to at least two or more mobile station devices 1, the base station device 3 selects a transmission scheme for use in data transmission from either one of an orthogonal access scheme and a non-orthogonal access scheme. When data transmission by the non-orthogonal access scheme is performed, the mobile station device 1 to which the non-orthogonal access scheme is applied is selected. Furthermore, after notifying the selected mobile station device 1 of information required for the mobile station device 1 to perform a reception process and information required for signal demultiplexing in the case of non-orthogonal access, the base station device 3 performs data transmission to the mobile station device 1. Based on the received control information, the mobile station device 1 performs signal demultiplexing in the reception process in the case of the non-orthogonal access scheme. While the number of mobile station devices 1 is two in the drawing, the number may be three or more, and the number of antennas for transmission and reception may be one or two or more.

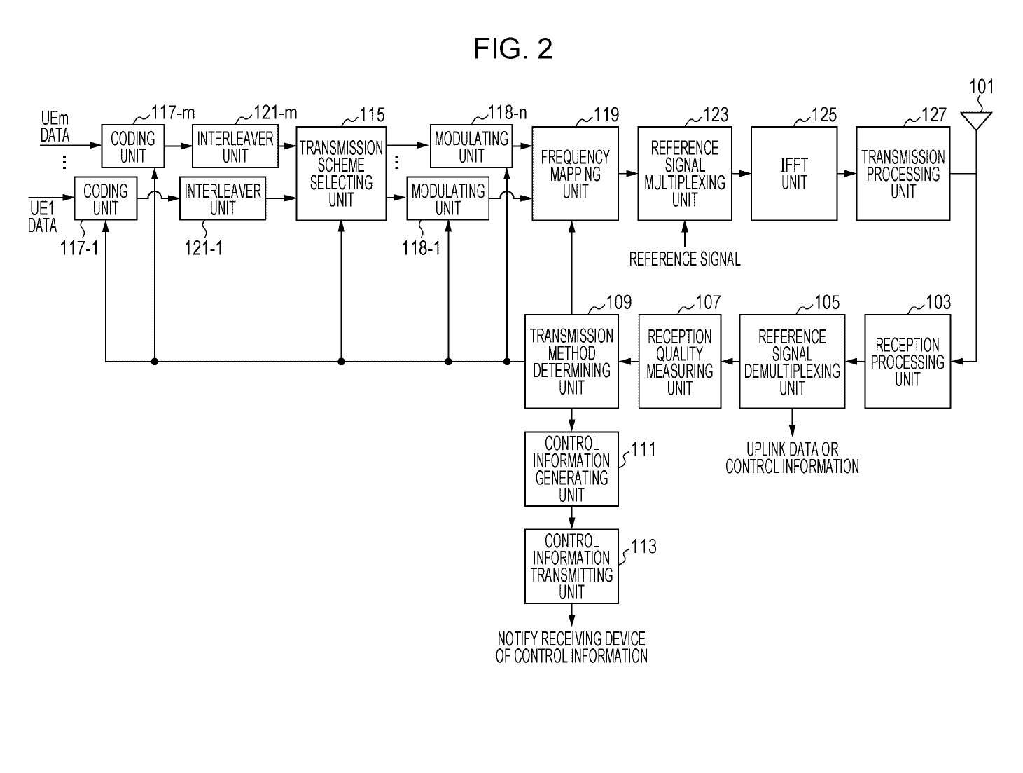

FIG. 2 is a schematic block diagram depicting an example of the base station device eNB3 according to the first embodiment of the present invention. The drawing is a minimum block diagram required for describing the present invention. The base station device 3 of FIG. 2 receives signals transmitted from a plurality of mobile station devices UE1-1 to UE1-m at an antenna 101, and inputs the signals to a reception processing unit 103. The reception processing unit 103 down-converts the inputted signals to a baseband frequency, performs A/D conversion on the down-converted signals to generate digital signals, cancels a cyclic prefix from the generated digital signals, and outputs the signals after cancellation to a reference signal demultiplexing unit 105.

The reference signal demultiplexing unit 105 demultiplexes the signals inputted from the reception processing unit 103 into a reference signal (sounding reference signal(SRS)) and a data signal and control information. The reference signal demultiplexing unit 105 outputs the reference signal obtained by demultiplexing to a reception quality measuring unit 107. With the reference signal inputted from the reference signal demultiplexing unit 105, the reception quality measuring unit 107 estimates channel performance (frequency response) between each of the mobile station devices UE1-1 to UE1-m and the antenna 101 for input to a transmission method determining unit 109. Regarding the channel performance, reception quality may be measured at each mobile station device and a notification may be made as uplink control information. From the inputted channel performance of the mobile station devices UE1-1 to UE1-m, the transmission method determining unit 109 determines a transmission scheme, a modulation scheme, a coding rate (the modulation scheme and the coding rate are hereinafter collectively referred to as a modulation and coding scheme (MCS)), frequency assignment, and so forth for use in performing data transmission to each mobile station device 1.

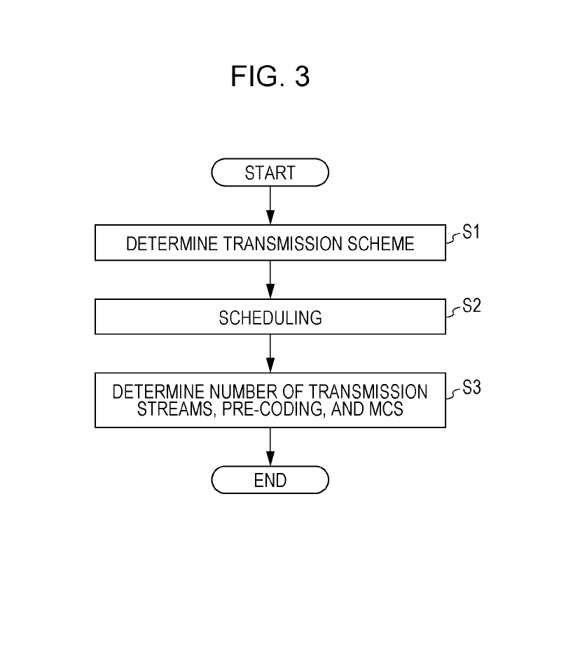

FIG. 3 is a flowchart depicting an example of a method of determining a transmission scheme, a modulation scheme, a coding rate, and so forth. First, it is determined whether the orthogonal access scheme or the non-orthogonal access scheme is used as a transmission scheme (step S1). Next, band assignment for each mobile station device 1 is determined by scheduling (step S2). Based on the determined transmission scheme and band assignment, an MCS, the number of transmission streams, pre-coding to be applied, and so forth are determined so as to satisfy the predetermined communication quality (step S3). Here, the transmission scheme may be determined simultaneously with band assignment for each mobile station device 1. Note that while the MCS often represents a combination of a modulation scheme and a coding rate, since the coding rate is uniquely determined from the number of information bits such as a transport block size, the modulation scheme, and the band width, a notification of such an MCS may be used.

Also, an example of the method of determining a transmission scheme from between the orthogonal access scheme and the non-orthogonal access scheme for each mobile station device 1 is not restricted to the example of FIG. 3. Channel performance, MCS, band assignment, and so forth of the mobile station device 1 may be determined, and a transmission scheme may be determined based on these information. When data transmission by non-orthogonal access scheme is performed, it is required to determine pairing indicating which mobile station device 1 non-orthogonal multiplexing is to be performed with. As an example of a pairing determining method, there is a method based on channel performance. Examples include a method of calculating signal to interference plus noise power ratios (SINRs) based on channel performance and band assignment and pairing mobile station devices 1 having an equivalent SINR and a method of pairing mobile station devices 1 having a difference between the calculated SINRs that is equal to or larger than a certain value. However, the pairing method is not restricted to the above, and a determination may be made based on the MCS determined by the transmission method determining unit 109 or may be made as part of scheduling.

Referring back to FIG. 2, the transmission method determining unit 109 inputs information such as the transmission scheme, MCS, and frequency assignment to a control information generating unit 111. The inputted control information is converted at the control information generating unit 111 to data in a control information format, and a receiving device is notified of the control information via a control information transmitting unit 113. On the other hand, the information about the transmission scheme and band assignment is also inputted to a transmission scheme selecting unit 115, and the information about the coding rate included in the MCS is inputted to coding units 117-1 to 117-m. Also, the information about the transmission scheme and the modulation scheme included in the MCS is inputted to modulating units (including layer assigning units, which will be described further below) 118-1 to 118-n (the modulating units 118-1 to 118-n are hereinafter also collectively represented as a modulating unit 118), and the information about frequency assignment is also inputted to a frequency mapping unit 119.

The coding units 117-1 to 117-m receive inputs of data bits to be transmitted to the mobile station devices UE1-1 to UE1-m and coding rates, and perform error correction coding on the inputted data bits. Example of error correction coding includes convolutional code, turbo code, and low density parity check (LDPC) code. The coded bits subjected to error correction coding are sorted at interleaver units 121-1 to 121-m (the interleaver units 121-1 to 121-m are hereinafter also collectively represented as an interleaver unit 121), and are inputted to the transmission scheme selecting unit 115. In the transmission scheme selecting unit 115, the information about the transmission scheme indicating whether the access scheme for each mobile station device 1 is the orthogonal access scheme or the non-orthogonal access scheme and information about the band assignment are inputted from the transmission method determining unit 109, and signals sorted at the interleaver units 121-1 to 121-m are inputted.

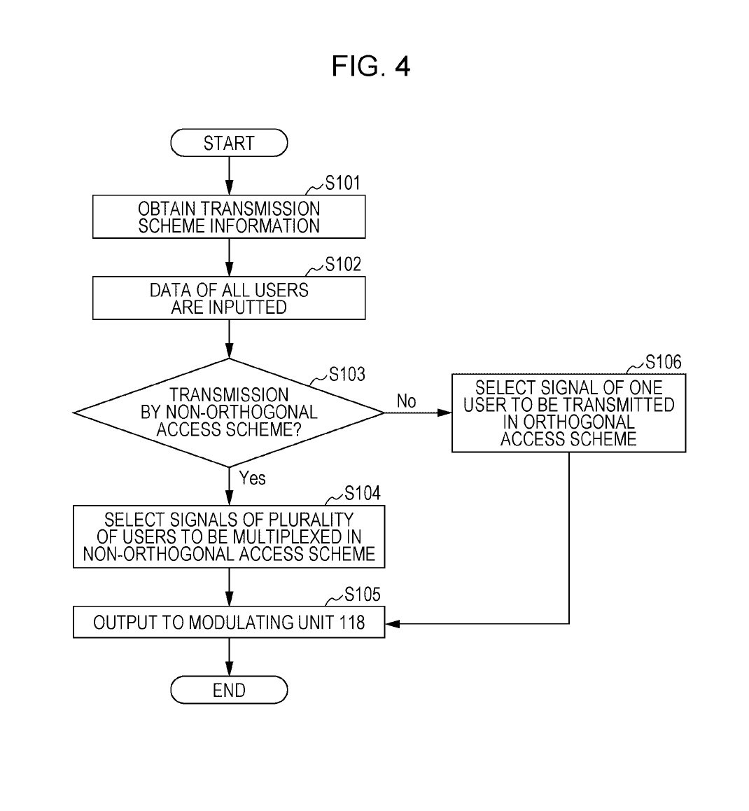

FIG. 4 is a flowchart depicting a signal process at the transmission scheme selecting unit 115 according to the first embodiment of the present invention. First, the transmission scheme selecting unit 115 obtains transmission scheme information (step S101). Also, data of all users are inputted (step S102). Next, the transmission scheme selecting unit 115 identifies whether transmission by the non-orthogonal access scheme is selected (step S103). When the non-orthogonal access scheme is selected (step S103: Yes), the transmission scheme selecting unit 115 inputs signals of mobile station devices 1 with the same frequency band selected (step S104) to the same modulating unit 118-i (1≦i≦n) (step S105). When the non-orthogonal access scheme is not selected (step S103: No), the transmission scheme selecting unit 115 inputs signals of a mobile station device 1 with the orthogonal access scheme selected (step S106) to a modulating unit 118-s (1≦s≦n) where signals of other mobile station devices 1 are not inputted (step S105). Here, when the mobile station device 1 with the same frequency band as that in band assignment of the mobile station device 1 with the non-orthogonal access scheme selected is not present, the transmission scheme selecting unit 115 may perform a process of regarding the scheme as the orthogonal access scheme. The transmission scheme selecting unit 115 performs the above-described process and outputs the results to the modulating units 118-1 to 118-n.

The modulating units 118-1 to 118-n receive inputs of data signals from the transmission scheme selecting unit 115, and receives inputs of the information about the modulation scheme and the transmission scheme for each mobile station device 1 from the transmission method determining unit 109.

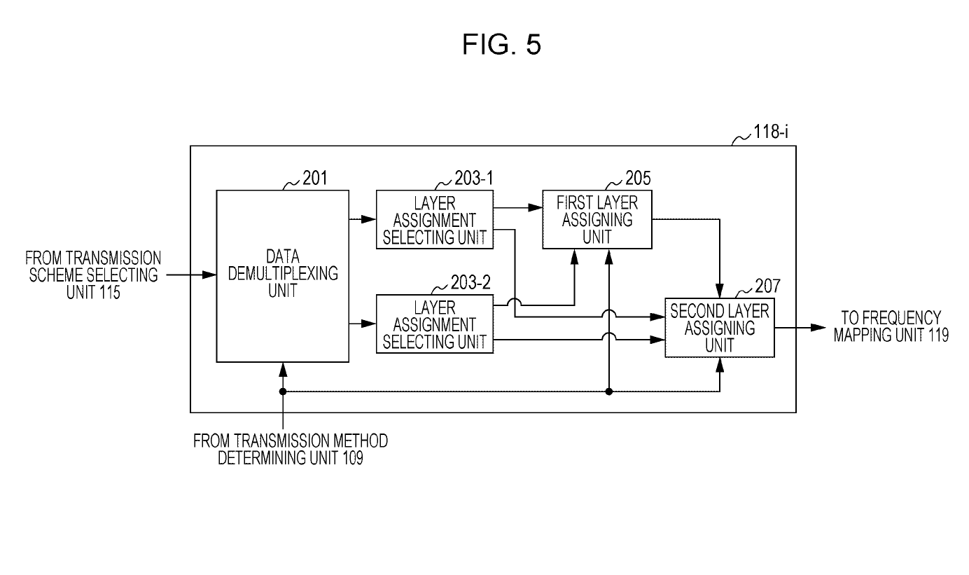

FIG. 5 is a block diagram depicting the structure of the modulating unit 118-i (1≦i≦n) according to the first embodiment of the present invention. The data signals, the modulation scheme, and the transmission scheme inputted to the modulating unit 118-i are inputted to a data demultiplexing unit 201. In the case of the non-orthogonal access scheme, since signals to be transmitted to the plurality of mobile station devices 1 are included, the data demultiplexing unit 201 demultiplexes the signals into signals for each mobile station device 1, and inputs the resultant signals to layer assignment selecting units 203-1 and 203-2 (the layer assignment selecting units 203-1 and 203-2 are hereinafter also collectively represented as a layer assignment selecting unit 203). In the case of the orthogonal access scheme, signals are inputted to only any layer assignment selecting unit 203.

The layer assignment selecting units 203-1 and 203-2 assign and input a signal to one mobile station device 1 to a first layer assigning unit 205 and a second layer assigning unit 207. As an assigning method, it is assumed that a ratio of assignment to a first layer and a second layer is configured in advance by tabulation or a definition equation and the signals are assigned to the first layer assigning unit 205 and the second layer assigning unit 207 based on this configured ratio. The first layer and the second layer are a layer with a long distance between signal points and a layer with a short distance between signal points, respectively, which will be described further below in detail. Examples of assignment to the first layer and the second layer include, as an assigning method when the ratio is 0.5 each, a method of inputting odd-numbered bits to the first layer assigning unit 205 and inputting even-numbered bits to the second layer assigning unit 207. In the present embodiment, the assigning method is not restricted to the above as long as the layer assignment selecting units 203-1 and 203-2 input a predetermined ratio of the inputted bits to the first layer assigning unit 205 and input the remaining signals to the second layer assigning unit 207.

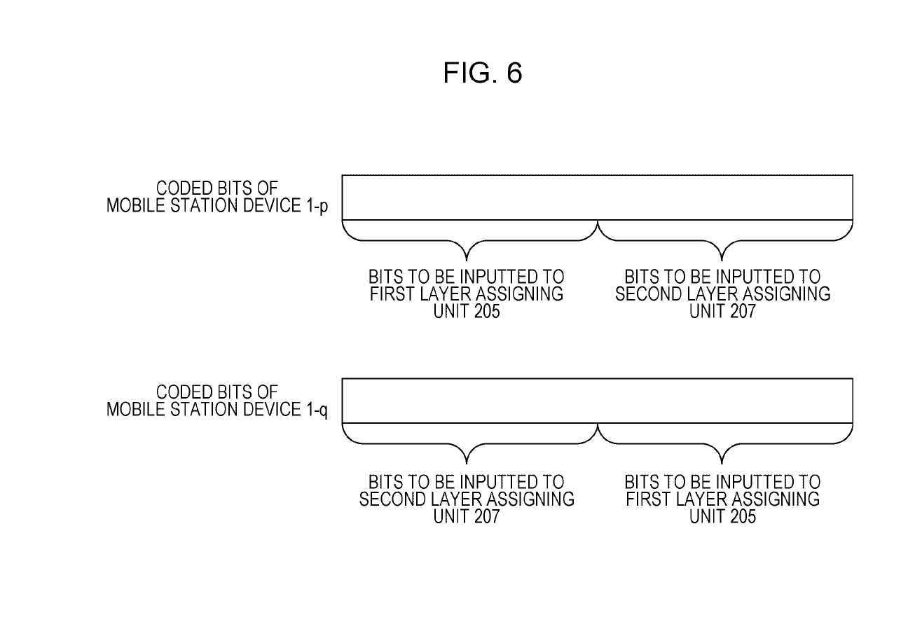

FIG. 6 is a diagram depicting an example of a layer assignment selecting method when signals of a mobile station device 1-p and a mobile station device 1-q according to the first embodiment of the present invention are multiplexed by the non-orthogonal access scheme. In the present embodiment, the layer assignment selecting units 203-1 and 203-2 input 50% of the inputted coded bits to the first layer assigning unit 205 and input the remaining 50% to the second layer assigning unit 207. Note that three or more users may be subjected to multiplexing and multiplexing may be performed so that one-third of the first layer and one-third of the second layer are used by each user.

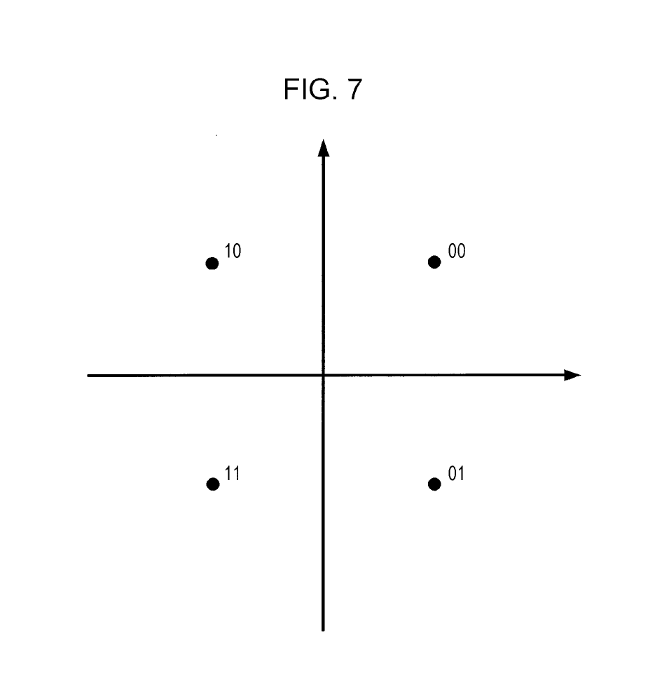

In the case of the non-orthogonal access scheme, the first layer assigning unit 205 performs first layer assignment depicted in FIG. 7 by using two bits to be transmitted to either one of the mobile station device 1 from among the inputted bits to be transmitted to the two mobile station devices 1.

FIG. 7 is a diagram depicting first layer assignment according to the first embodiment of the present invention. The first layer is for assignment of QPSK modulation. At this point in time, the process is similar to QPSK modulation in the orthogonal access scheme, and a modulated signal m(k) is represented by Equation (1) when the first bit for modulation is taken as b₁(k) and the second bit is taken as b₂(k).

$$\begin{matrix}[ Equation 1 ] & \\ m ( k ) = \frac{1}{\sqrt{2}} \{ ( 1 - 2 {b}_{1} ( k ) ) + j ( 1 - 2 {b}_{2} ( k ) ) \} & ( 1 )\end{matrix}$$

This QPSK-modulated signal is inputted to the second layer assigning unit 207. In the second layer assigning unit 207, from among the inputted bits to be transmitted to two mobile station devices 1, modulation is performed by using two bits to be transmitted to the mobile station device 1 different from the mobile station device 1 used for modulation at the first layer assigning unit 205.

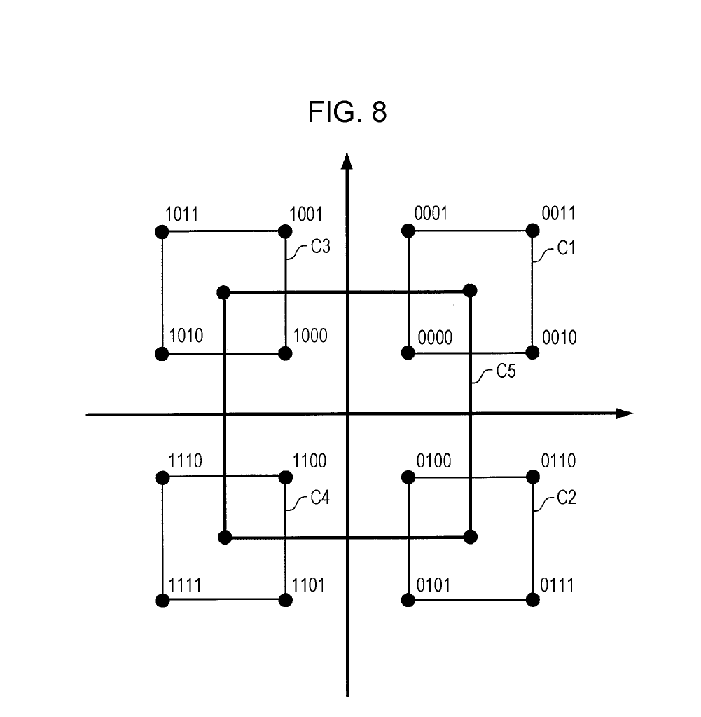

FIG. 8 is a diagram depicting a modulation method to be performed by the second layer assigning unit 207 according to the first embodiment of the present invention. The second layer assigning unit 207 performs assignment to signal points of any of second layers C1 to C4 with a short distance between signal points depicted in FIG. 8. In the second layer assigning unit 207, since an input signal from the first layer assigning unit 205 is arranged at any signal point in C5, a quadrant for assignment is determined. Furthermore, with two bits to be multiplexed at the second layer assigning unit 207, it is determined at which signal point in the same quadrant as that of the input signal from the first layer assigning unit 205 from among C1 to C4 assignment is to be performed. Therefore, an output from the second layer assigning unit 207 is 16 QAM modulated signal, as depicted in FIG. 8. Here, the signal point arrangement in the quadrant is in the second layer. An output signal m(k) of the second layer assigning unit 207 is represented by Equation (2) when the first bit for modulation is taken as b₃(k) and the second bit is taken as b₄(k).

$$\begin{matrix} [ Equation 2 ] & \\ m ( k ) = \frac{1}{\sqrt{10}} \{ sgn ( 1 - 2 {b}_{1} ( k ) ) ( 2 {b}_{3} ( k ) + 1 ) + j sgn ( 1 - 2 {b}_{2} ( k ) ) ( 2 {b}_{4} ( k ) + 1 ) \} & ( 2 )\end{matrix}$$

where sgn( ) is a signum function, indicating 1 when the value in parentheses is positive, and −1 when the value in parentheses is negative. Also, m(k) means a k-th modulated signal. When the number of modulation symbols is M, 1≦k≦M is obtained. The modulated signal outputted from the second layer assigning unit 207 is inputted to the frequency mapping unit 119.

Referring back to FIG. 2, the frequency mapping unit 119 performs signal assignment on the inputted modulated signal based on band assignment information notified by the transmission method determining unit 109. On the other hand, in a reference signal multiplexing unit 123, a reference signal is inputted, and a data signal and a reference signal are multiplexed together. While the structure is such that the reference signal is multiplexed in a frequency domain in the present example, the structure may be such that the reference signal is multiplexed in a time domain.

The signal multiplexed with the reference signal is converted to a signal in the time domain at an IFFT unit 125. Into the signal in the time domain inputted from the IFFT unit 125, a cyclic prefix (CP) is inserted at a transmission processing unit (transmitting unit) 127, and the resultant signal is converted by digital/analog (D/A) conversion to an analog signal, and then is up-converted to a radio frequency. The up-converted signal is amplified by a power amplifier (PA) to transmission power and is then transmitted from the antenna 101.

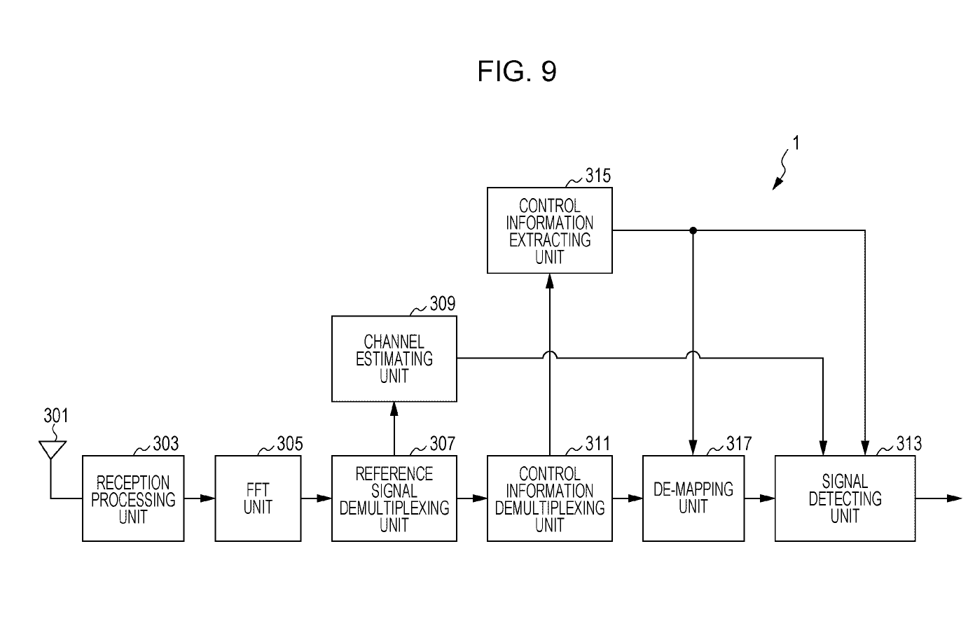

FIG. 9 is a block diagram depicting an example of structure of a mobile station device 1, which is a receiving device having one receive antenna in the first embodiment of the present invention. However, a plurality of receive antennas may be provided. In the receiving device, the signal from the transmitting device is received at an antenna 301, is down-converted at a reception processing unit 303 to a baseband frequency, and is converted by A/D conversion to a digital signal, and the CP is cancelled from the digital signal. The signal outputted from the reception processing unit 303 is converted at an FFT unit 305 from the signal in the time domain to a signal in the frequency domain. A reference signal demultiplexing unit 307 demultiplexes the inputted signal in the frequency domain into the reference signal and the data signal, and the reference signal is outputted to a channel estimating unit 309 and the data signal or the signal of the control information is outputted to a control information demultiplexing unit 311. With the known reference signal at the transmitting and receiving devices, the channel estimating unit 309 estimates a channel frequency response. The estimated channel performance is outputted to a signal detecting unit (including a layer demodulating unit, which will be described further below) 313.

On the other hand, the control information demultiplexing unit 311 demultiplexes the signal inputted from the reference signal demultiplexing unit 307 into the data signal and the signal of the control information, and the signal of the control information is inputted to a control information extracting unit 315 and the data signal is inputted to a de-mapping unit 317. The control information extracting unit 315 extracts information about the transmission scheme, MCS, and band assignment used in data transmission included in the inputted control information and inputs the information to the signal detecting unit 313, and inputs the information about band assignment to the de-mapping unit 317. The de-mapping unit 317 extracts a reception signal in the frequency domain based on the band assignment information and inputs the reception signal to the signal detecting unit 313.

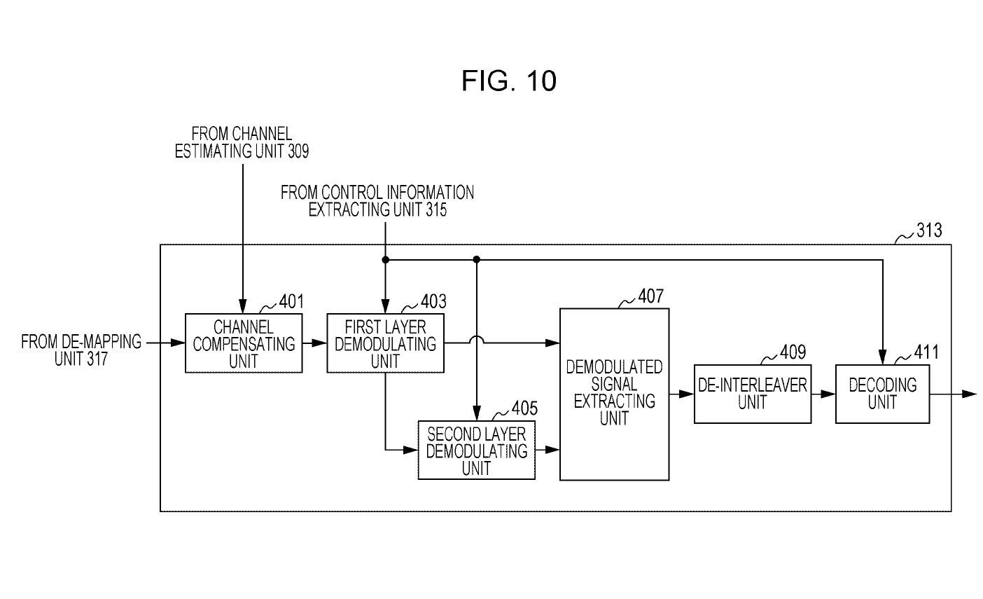

FIG. 10 is block diagram depicting an example of structure of the signal detecting unit 313 according to the first embodiment of the present invention. In the signal detecting unit 313, the reception signal in the frequency domain inputted from the de-mapping unit 317 and the channel performance estimated by the channel estimating unit 309 are inputted to a channel compensating unit 401. The channel compensating unit 401 performs a process of compensating for distortion of the radio channel based on the inputted channel performance, and then inputs the result to a first layer demodulating unit 403. From the modulated signal received from the channel compensating unit 401, the first layer demodulating unit 403 obtains a log likelihood ratio (LLR) of two bits modulated at the first layer assigning unit 205 of the transmitting device, with the signal QPSK-modulated in FIG. 7 being regarded as transmitted. Furthermore, a second layer demodulating unit 405 receives inputs of a received modulated signal r and information of bits detected at the first layer demodulating unit 403. In the second layer demodulating unit 405, from the inputted LLR from the first layer demodulating unit 403, transmitted bits are found. The modulated signal s is found from the transmitted bits found from the LLR and Equation (1), and a QPSK signal z with a short distance between signal points is obtained from Equation (3).

z=r−s (3)

By demodulating z, information of two bits modulated at the second layer assigning unit 207 is obtained. The LLR obtained at the first layer demodulating unit 403 and the second layer demodulating unit 405 is inputted to a demodulated signal extracting unit (extracting unit) 407.

Based on the layer assigning method determined in advance, the demodulated signal extracting unit 407 extracts only the LLR to be decoded, and inputs the extracted LLR to a de-interleaver unit 409. The de-interleaver unit 409 performs an operation in reverse to data sorting performed in the interleaver unit 121 of the transmitting device to sort in the order of the coded bits. A decoding unit 411 performs error correction decoding based on the information about the coding rate to obtain data bits. Here, when turbo code or convolutional code is used, error correction decoding with a maximum a posteriori (Max-Log-MAP) algorithm or the like is performed. When LDPC code is used, error correction decoding with a Sum-Product algorithm or the like is performed.

While a layer assigning method is determined in advance in the present embodiment, a notification may be made with control information. For example, a first layer assigning method is a method in which odd-numbered modulation symbols are modulated by the first layer assigning unit 205 and even-numbered modulation symbols are modulated by the second layer assigning unit 207 in the signal to be transmitted. A second layer assigning method is a method in which even-numbered modulation symbols are modulated by the first layer assigning unit 205 and odd-numbered modulation symbols are modulated by the second layer assigning unit 207 in the signal to be transmitted. In this case, the mobile station device 1 is required to know which of the first and second layer assigning methods is to be used for assignment, and is notified with control information of one bit. The above-described layer assigning methods are examples, and another assigning method may be used in which, for example, the assignment layer is changed for every two symbols. Also, a notification of the information about the layer assigning method is not made as control information but may be made in association with other control information. For example, a plurality of patterns of the layer assigning method may be determined in advance in the transmitting and receiving devices, and a notification about which pattern is to be used may be made with information about a modulation order, which is information about a modulation scheme, or with antenna port information. In another example, information about the coding rate, transmission power control, and so forth may be used.

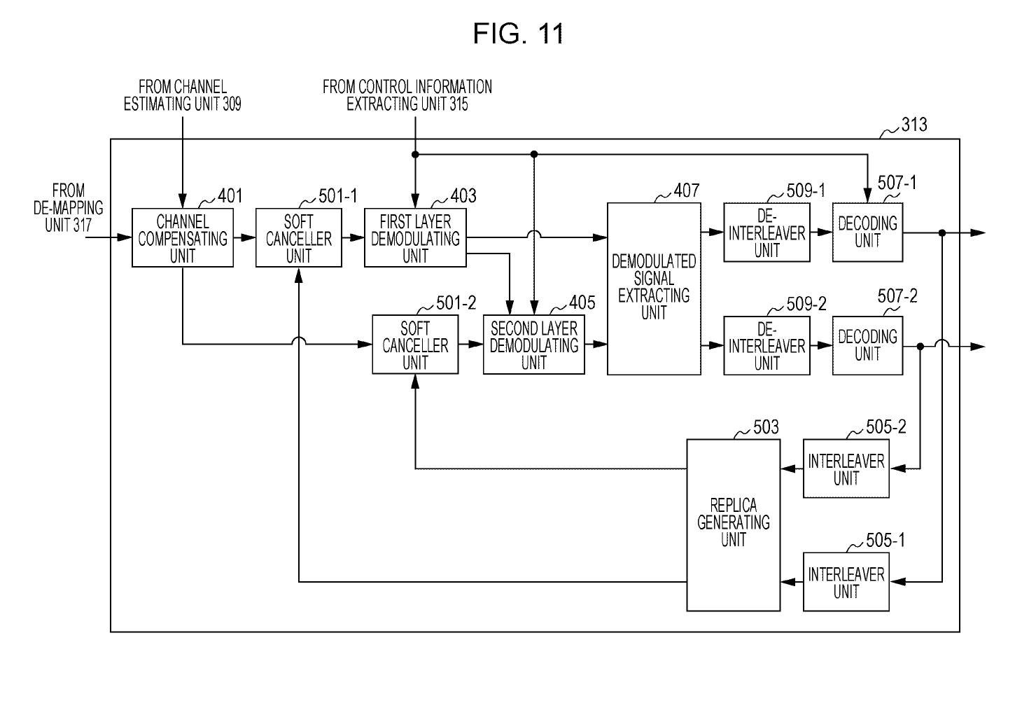

FIG. 11 is a block diagram depicting another example of structure of the signal detecting unit 313 according to the first embodiment of the present invention. In FIG. 11, the example of structure of the signal detecting unit 313 which performs reception by a nonlinear iterative process is depicted. FIG. 11 is different from FIG. 10 in that soft canceller units 501-1 and 501-2, a replica generating unit 503, and interleaver units 505-1 and 505-2 are added. Processes similar to those in FIG. 10 are not described herein. The interleaver units 505-1 and 505-2 receive inputs of the LLRs after decoding obtained by decoding units 507-1 and 507-2, sort the inputted signals in a similar manner to that of the interleaver unit 121 of the transmitting device, and then input the resultant signals to the replica generating unit 503.

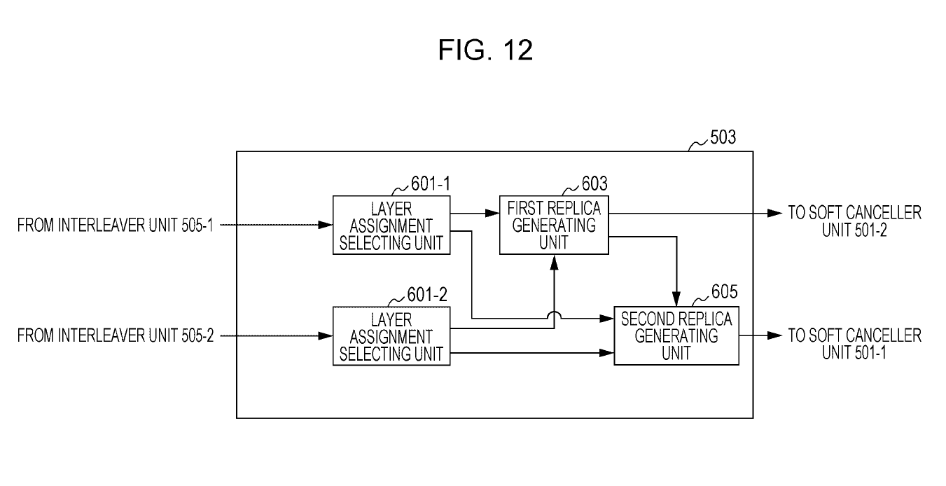

FIG. 12 is a block diagram depicting an example of structure of the replica generating unit 503 according to the first embodiment of the present invention. The replica generating unit 503 inputs the LLRs inputted from the interleaver units 505-1 and 505-2 to layer assignment selecting units 601-1 and 601-2. The layer assignment selecting units 601-1 and 601-2 performs processes similar to those of the layer assignment selecting units 203-1 and 203-2 of the transmitting device, and output the results to a first replica generating unit 603 and a second replica generating unit 605. In the first replica generating unit 603, the LLR of bits modulated at the first layer assigning unit 205 is inputted, a replica sᵣₑₚ₁(k) is generated with Equation (4), and the result is outputted to a soft canceller unit 501-2.

$$\begin{matrix}[ Equation 3 ] & \\ {s}_{rep 1} ( k ) = - \frac{1}{\sqrt{2}} \{ tan h ( {LLR}_{1} ( k ) / 2 ) + j tan h ( {LLR}_{2} ( k ) / 2 ) \} & ( 4 )\end{matrix}$$

where k is a number of the modulation symbol. When the number of modulation symbols is M, 1≦k≦M is satisfied, and LLR₁(k) and LLR₂(k) are the first bit LLR and the second bit LLR, respectively, used for a k-th modulation symbol at the first layer assigning unit 205.

In the second replica generating unit 605, an output of the first replica generating unit 603 and the LLR of the bits modulated at the second layer assigning unit 207 are inputted, a replica sᵣₑₚ₂(k) is generated with Equation (5), and the result is outputted to a soft canceller unit 501-1.

$$\begin{matrix} [ Equation 4 ] & \\ {s}_{rep 2} ( k ) = \frac{1}{\sqrt{10}} \{ sgn ( {LLR}_{3} ( k ) Re [ {s}_{rep 1} ] ) tan h ( {LLR}_{3} ( k ) / 2 ) + j sgn ( {LLR}_{4} ( k ) Im [ {s}_{rep 1} ] ) tan h ( {LLR}_{4} ( k ) / 2 ) \} & ( 5 )\end{matrix}$$

where Re[ ] is a function which returns a real part value, Im[ ] is a function which returns an imaginary part value, and LLR₃(k) and LLR₄(k) are LLRs of bits used for the k-th modulation symbol at the second layer assigning unit 207.

Referring back to FIG. 11, in the soft canceller unit 501-1, modulation by the second layer assigning unit 207 causes inter user interference (IUI), and therefore the inter user interference is cancelled. Here, when feedback is complete, the output of the soft canceller unit 501-1 becomes a signal with the signal points in FIG. 7 multiplied with channel performance. In the soft canceller unit 501-2, modulation by the first layer assigning unit 205 causes inter user interference, and therefore the inter user interference is cancelled. However, the soft canceller units 501-1 and 501-2 do not subtract anything at the first iteration without inputs from the replica generating unit 503.

The first layer demodulating unit 403 performs a process similar to that of FIG. 10, and the second layer demodulating unit 405 does not perform Equation (3) but performs a demodulating process similar to that of FIG. 10. A demodulated signal extracting unit 407 performs a process similar to that of FIG. 10, and then inputs all signals multiplexed with the reception signal to de-interleaver units 509-1 and 509-2. The de-interleaver units 509-1 and 509-2 perform an operation in reverse to data sorting performed in the interleaver unit 121 of the transmitting device to sort in the order of the coded bits, and then input the results to decoding units 507-1 and 507-2. With a notification of the information about the coding rates of all signals multiplexed with the reception signal being regarded as being made, the decoding units 507-1 and 507-2 perform error correction decoding based on the information about the coding rate, and obtain data bits.

While the number of layers for hierarchical modulation is two in the present embodiment, the number of layers may be three or more. Also, the number of users for multiplexing by hierarchical modulation may be three or more. Furthermore, while assignment of the signal to be transmitted to the specific mobile station device 1 is switched to the first layer and the second layer for each modulation symbol in the present embodiment, switching may be made for each OFDM symbol. Specifically, for example, the signal to be transmitted to the specific mobile station device 1 is assigned to the first layer in an L-th OFDM symbol, and the signal is assigned to the second layer in an (L+1)-th OFDM symbol. However, switching of the layer for assignment is not required to be for every OFDM symbol, but may be for every two or more OFDM symbols. Furthermore, while the example in which multiplexing is performed by hierarchical modulation with OFDM as a multicarrier has been described, the present embodiment may be applied to DFT-S-OFDM and clustered DFT-S-OFDM with a single carrier.

As described above, when hierarchical modulation is used as non-orthogonal access in a downlink, by assigning a predetermined ratio of signals of the mobile station devices 1 to be multiplexed to the first layer and assigning the remaining signals to the second layer, unevenness in reception quality due to non-orthogonal access among the mobile station devices 1 is prevented from occurring. As a result, the mobile station device 1 assigned to only the second layer is not present, and an improvement in cell throughput and spectral efficiency can be achieved.

### Second Embodiment

While the ratio of signals to be assigned to each layer is fixed in the previous embodiment, the ratio is controlled in the present embodiment. The structures of a transmitting device and a receiving device in the present embodiment are similar to those of the above-described first embodiment, and are as in FIG. 2 and FIG. 9, respectively. However, the processes of the transmission method determining unit 109 and the modulating units 118-1 to 118-n of the transmitting device are different. Since other processes are similar, they are not described herein.

The transmission method determining unit 109 determines a transmission scheme, MCS, frequency assignment, and so forth for use in data transmission to each mobile station device 1 based on the inputted channel performance of the mobile station devices UE1-1 to UE1-m. The transmission scheme determines, in addition to information indicating which of the orthogonal access scheme or the non-orthogonal access scheme is to be used, ratios X_{L1}(p) and X_{L2}(p) of assignment of signals to be transmitted to the mobile station device 1-p for transmission by the non-orthogonal access scheme to the first layer and the second layer. When the mobile station device 1-p and the mobile station device 1-q for multiplexing by the non-orthogonal access scheme are paired, the ratios of assignment to the first layer and the second layer are determined so as to satisfy Equations (6) to (9).

X_{L1}(p)+X_{L2}(p)=1 (6)

X_{L1}(q)+X_{L2}(q)=1 (7)

X_{L1}(p)+X_{L1}(q)=1 (8)

X_{L2}(p)+X_{L2}(q)=1 (9)

The method of determining the ratios X_{L1}(p) and X_{L2}(p) of assignment to the first layer and the second layer is assumed to be performed based on the channel performance, MCS, band assignment, and so forth of the mobile station devices 1. As another example, a determination is made based on a new data indicator (NDI) indicating whether the transmission is an initial transmission or re-transmission or the like. In an example of a method of determining X_{L1}(p) and X_{L2}(p) based on the channel performance and band assignment information, each SINR is calculated based on the channel performance and band assignment, and the ratio of assignment to the first layer in the mobile station device 1 with a high SINR is set higher. In this example, when the calculated SINR of the mobile station device 1-p is higher than that of the mobile station device 1-q, it is set that X_{L1}(p)>X_{L1}(q) and X_{L2}(p)>X_{L2}(q). In a specific example, it is set that X_{L1}(p)=0.8 and X_{L1}(q)=0.2. However, the present embodiment is not restricted to the example of these values as long as the ratio of each layer is determined based on the channel performance.

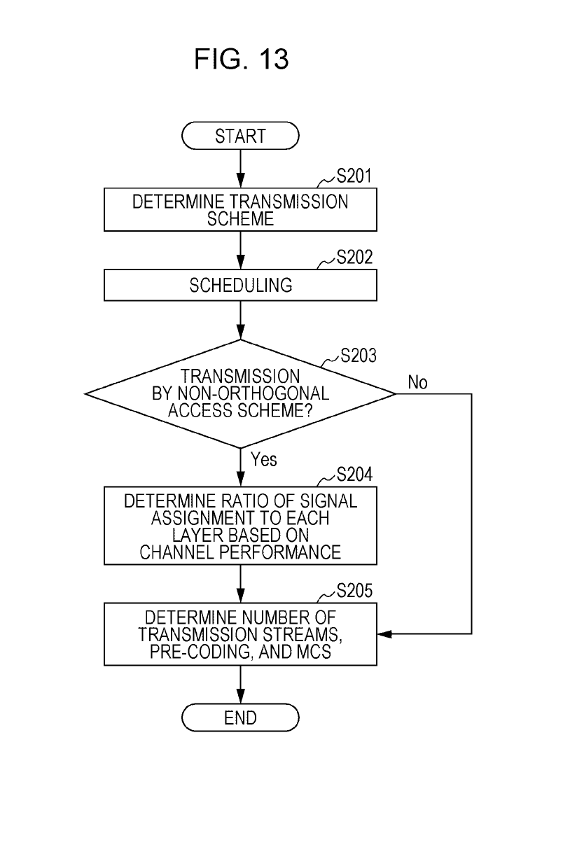

FIG. 13 is a flowchart depicting an example of a process at the transmission method determining unit 109 according to the second embodiment of the present invention. The transmission method determining unit 109 determines the orthogonal access scheme or the non-orthogonal access scheme based on the inputted channel information (step S201), and determines frequency assignment by scheduling (step S202). Next, the transmission method determining unit 109 determines whether the determined scheme is the non-orthogonal access scheme (step S203). When the scheme is the non-orthogonal access scheme (step S203: Yes), the transmission method determining unit 109 determines a ratio of assignment of signals to each layer so as to satisfy Equations (6) to (9) based on the channel performances of the plurality of users for which the scheme is determined as the non-orthogonal access scheme (step S204). Then, the transmission method determining unit 109 determines the number of transmission streams, pre-coding, and MCS (step S205). On the other hand, when the scheme is not the non-orthogonal access scheme (step S203: No), the transmission method determining unit 109 performs the process at step S205.

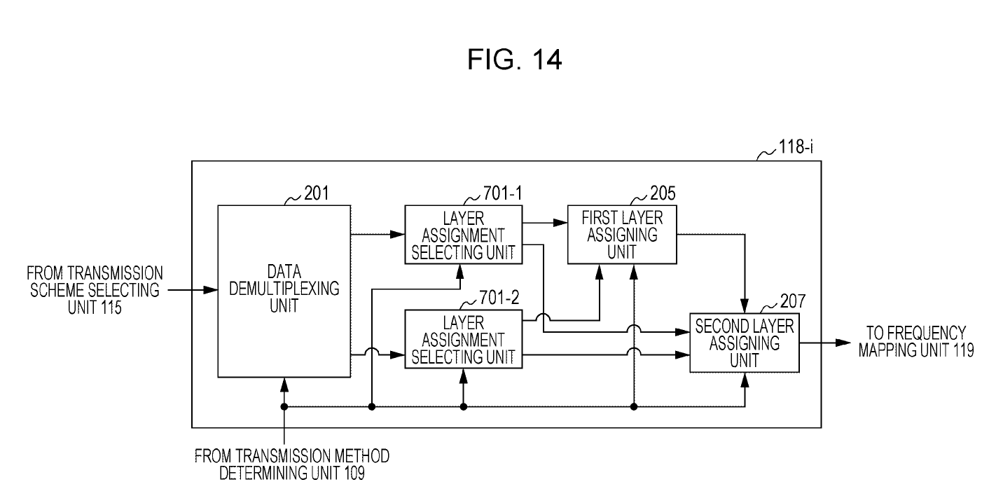

FIG. 14 is a block diagram depicting an example of structure of the modulating units 118-1 to 118-n according to the second embodiment of the present invention. The data demultiplexing unit 201 performs a process similar to that of the previous embodiment. In the case of the non-orthogonal access scheme, the coded bits of the respective mobile station devices 1 are inputted to layer assignment selecting units 701-1 and 701-2. The layer assignment selecting units 701-1 and 701-2 receive, from the transmission method determining unit 109, inputs of information about the ratios of assignment to the first layer and the second layer. When the coded bits of the mobile station device 1-p are inputted to the layer assignment selecting unit 701-1, X_{L1}(p) and X_{L2}(p) are inputted and, based on these ratios, the coded bits to be outputted to the first layer assigning unit 205 and the second layer assigning unit 207 are inputted. Similarly, when the coded bits of the mobile station device 1-q are inputted to the layer assignment selecting unit 701-2, X_{L1}(q) and X_{L2}(q) are inputted and, based on these ratios, the coded bits to be outputted to the first layer assigning unit 205 and the second layer assigning unit 207 are inputted. The subsequent processes are similar to those of the previous embodiment.

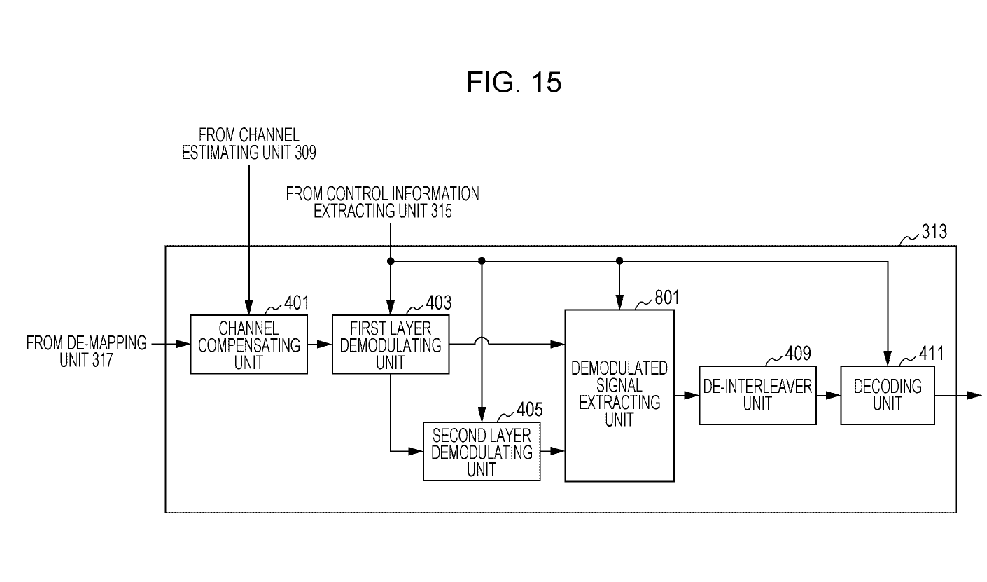

FIG. 15 is a block diagram depicting an example of structure of the signal detecting unit 313 according to the second embodiment of the present invention. While the receiving device according to the present embodiment is similar to that of FIG. 9, the process of the signal detecting unit 313 is different. The processes of the channel compensating unit 401, the first layer demodulating unit 403, and the second layer demodulating unit 405 are similar to those of the previous embodiment. In a demodulated signal extracting unit 801, LLRs are inputted from the first layer demodulating unit 403 and the second layer demodulating unit 405, and information about the ratios of assignment to the first layer and the second layer are inputted from the control information extracting unit 315. The demodulated signal extracting unit 801 extracts only the LLR to be decoded based on the layer assignment ratios and the layer assigning method determined in advance, and inputs the extracted LLR to the de-interleaver unit 409. The subsequent processes are similar to those of the previous embodiment.

While the number of layers for hierarchical modulation is two in the present embodiment, the number of layers may be three or more. Also, the number of users for multiplexing by hierarchical modulation may be three or more. Furthermore, while assignment of the signal to be transmitted to the specific mobile station device 1 is switched to the first layer and the second layer for each modulation symbol in the present embodiment, switching may be made for each OFDM symbol. Specifically, for example, the signal to be transmitted to the specific mobile station device 1 is assigned to the first layer in an L-th OFDM symbol, and the signal is assigned to the second layer in an (L+1)-th OFDM symbol. However, switching of the layer for assignment is not required to be for every OFDM symbol, but may be for every two or more OFDM symbols. Furthermore, while the example in which multiplexing is performed by hierarchical modulation with OFDM as a multicarrier has been described, the present embodiment may be applied to DFT-S-OFDM and clustered DFT-S-OFDM with a single carrier.

As described above, when hierarchical modulation is used as non-orthogonal access in a downlink, by controlling the ratio of assignment of signals of the mobile station device 1 for multiplexing to the first layer and the ratio of assignment to the second layer, the mobile station device 1 assigned to only the second layer is not present, and an improvement in cell throughput and spectral efficiency can be achieved.

### Modification Example of Second Embodiment

A modification example in the second embodiment is described. While it is predicated in the second embodiment that a notification of the information about the ratios of assignment to the first layer and the second layer is made as control information, the case is described in the present modification example in which a notification is not made as control information. The structures of a transmitting device and a receiving device in the present modification example are similar to those of the first and second embodiments, and are as in FIG. 2 and FIG. 9, respectively. However, only the transmission method determining unit 109 of the transmitting device is different from that of the second embodiment.

The transmission method determining unit 109 determines a transmission scheme, MCS, frequency assignment, and so forth for use in data transmission to each mobile station device 1 based on the inputted channel performance of the mobile station devices UE1-1 to UE1-m. The transmission scheme determines, in addition to information indicating which of the orthogonal access scheme or the non-orthogonal access scheme is to be used, ratios X_{L1}(p) and X_{L2}(p) of assignment of signals to the mobile station device 1-p for transmission by the non-orthogonal access scheme to the first layer and the second layer. The ratios of assignment to the first layer and the second layer are determined in association with the information about the MCS. In an example of a method of making a determination based on a coding rate r_{c}, the following table is used.

TABLE 1

| | Ratio of assignment | Ratio of assignment |
|---|---|---|
| | to the first layer | to the second layer |
| Coding rate (r_{c}) | (X_{L1}) | (X_{L2}) |
| 1/3 | 0.25 | 0.75 |
| 1/2 | 0.5 | 0.5 |
| 2/3 | 0.75 | 0.25 |

However, the above is an example, and the above values are not restrictive as long as the ratios of layer assignment are determined based on the coding rate.

The ratios of assignment to the first layer and the second layer may be determined by using the information about the modulation scheme (modulation order). In this case, when the non-orthogonal access scheme is taken as the modulation method of FIG. 8, it is not required to make a notification of the modulation order as the control information, and therefore this information is used for a notification of the ratios of assignment to the first layer and the second layer. In an example of a method of using the modulation order, the following table is used.

TABLE 2

| | Ratio of assignment | Ratio of assignment |
|---|---|---|
| | to the first layer | to the second layer |
| Modulation order | (X_{L1}) | (X_{L2}) |
| 1 | 0.2 | 0.8 |
| 2 | 0.4 | 0.6 |
| 4 | 0.6 | 0.4 |
| 6 | 0.8 | 0.2 |

However, the above is an example, and the above values are not restrictive as long as the ratios of layer assignment are determined based on the modulation order.

The receiving device is similar to that of FIG. 9, but the process at the signal detecting unit 313 is different. An example of structure of the signal detecting unit 313 is as depicted in FIG. 15 of the second embodiment. The processes of the channel compensating unit 401, the first layer demodulating unit 403, and the second layer demodulating unit 405 are similar to those of the previous embodiment. In the demodulated signal extracting unit 801, LLRs are inputted from the first layer demodulating unit 403 and the second layer demodulating unit 405, and MCS information is inputted from the control information extracting unit 315. The demodulated signal extracting unit 801 calculates a ratio of layer assignment based on the association between the MCS and layer assignment ratio known between transmission and reception. Furthermore, based on the layer assignment ratio and the layer assigning method determined in advance, the demodulated signal extracting unit 801 extracts only the LLR to be decoded, and inputs the LLR to the de-interleaver unit 409. The subsequent processes are similar to those of the previous embodiment.

Also, the process at the transmission method determining unit 109 according to the modification example of the second embodiment is similar in process when compared with FIG. 13 of the second embodiment, expect that the ratio of signals to be assigned to each layer in step S204 is determined in association with the coding rate and the modulation scheme.

While the number of layers for hierarchical modulation is two in the modification example of the second embodiment, the number of layers may be three or more. Also, the number of users for multiplexing by hierarchical modulation may be three or more. Furthermore, while assignment of the signal to be transmitted to the specific mobile station device 1 is switched to the first layer and the second layer for each modulation symbol in the modification example of the second embodiment, switching may be made for each OFDM symbol. Specifically, for example, the signal to be transmitted to the specific mobile station device 1 is assigned to the first layer in an L-th OFDM symbol, and the signal is assigned to the second layer in an (L+1)-th OFDM symbol. However, switching of the layer for assignment is not required to be for every OFDM symbol, but may be for every two or more OFDM symbols. Furthermore, while the example in which multiplexing is performed by hierarchical modulation with OFDM as a multicarrier has been described, the present embodiment may be applied to DFT-S-OFDM and clustered DFT-S-OFDM with a single carrier.

As described above, when hierarchical modulation is used as non-orthogonal access in a downlink, by controlling the ratio of assignment of signals of the mobile station device 1 for multiplexing to the first layer and the ratio of assignment to the second layer without making a notification with the control information, the mobile station device 1 assigned to only the second layer is not present, and an improvement in cell throughput and spectral efficiency can be achieved.

### Third Embodiment

The structures of a transmitting device and a receiving device in the present embodiment are similar to those of the above-described first embodiment, and are as in FIG. 2 and FIG. 9, respectively. However, the transmission method determining unit 109 of the transmitting device is different. Other processes are similar, and therefore are not described herein.

The transmission method determining unit 109 determines a transmission scheme, MCS, frequency assignment, and so forth for use in data transmission to each mobile station device 1 based on the inputted channel performance of the mobile station devices UE1-1 to UE1-m. The transmission scheme determines, in addition to information indicating which of the orthogonal access scheme or the non-orthogonal access scheme is to be used, ratios X_{L1}(p) and X_{L2}(p) of assignment of signals to the mobile station device 1-p for transmission by the non-orthogonal access scheme to the first layer and the second layer. When the mobile station device 1-p and the mobile station device 1-q for multiplexing by the non-orthogonal access scheme are paired, the ratios of assignment to the first layer and the second layer are determined so as to satisfy Equations (6) to (9).

The method of determining the ratios X_{L1}(p) and X_{L2}(p) of assignment to the first layer and the second layer is determined with a process similar to that of the second embodiment. In the present embodiment, the transmission method determining unit 109 determines information about the coding rate included in the MCS when X_{L1}(p) and X_{L2}(p) are determined. Since an error rate tends to occur in the mobile station device 1 with a low ratio of the first layer, a low coding rate is applied. For example, a determination is made by using the relation of Table 1. The subsequent processes are similar to those of the previous embodiment.

Also, the process at the transmission method determining unit 109 according to the third embodiment is similar in process when compared with FIG. 13 of the second embodiment, expect for the MCS determining method at step S205.

While the number of layers for hierarchical modulation is two in the third embodiment, the number of layers may be three or more. Also, the number of users for multiplexing by hierarchical modulation may be three or more. Furthermore, while assignment of the signal to be transmitted to the specific mobile station device 1 is switched to the first layer and the second layer for each modulation symbol in the third embodiment, switching may be made for each OFDM symbol. Specifically, for example, the signal to be transmitted to the specific mobile station device 1 is assigned to the first layer in an L-th OFDM symbol, and the signal is assigned to the second layer in an (L+1)-th OFDM symbol. However, switching of the layer for assignment is not required to be for every OFDM symbol, but may be for every two or more OFDM symbols. Furthermore, while the example in which multiplexing is performed by hierarchical modulation with OFDM as a multicarrier has been described, the present embodiment may be applied to DFT-S-OFDM and clustered DFT-S-OFDM with a single carrier.

As described above, when hierarchical modulation is used as non-orthogonal access in a downlink, by determining the coding rate based on the ratio of signals of the mobile station devices 1 to be multiplexed to the first layer and the ratio of assignment to the second layer, an increase in error of the mobile station device 1 with a high ratio of assignment to the second layer can be avoided, and an improvement in cell throughput and spectral efficiency can be achieved.

A program operating on the mobile station device 1 and the base station device 3 associated with the present invention is a program (program to function a computer) for controlling a CPU and others so as to achieve the functions of the above-described embodiment associated with the present invention. And, information handled in these devices is temporarily accumulated in a RAM at the time of processing, and is then stored in various ROMs and HDDs and is read, corrected, and written by the CPU as required. As a recording medium for storing the program, any of semiconductor media (for example, a ROM, non-volatile memory card, and so forth), optical recording media (for example, a DVD, MO, MD, CD, BD, and so forth), magnetic recording media (for example, a magnetic tape, flexible disk, and so forth), and so forth may be used.

Also, the functions of the above-described embodiments are achieved by executing the loaded program, and the functions of the present invention may also be achieved by processing based on an instruction of the program in coordination with an operating system or another application program or the like. Furthermore, when the program is distributed in the market, the program can be stored in a portable-type recording medium for distribution or can be transferred to a server computer connected via a network such as the Internet. In this case, a storage device of the server computer is included in the present invention.

Still further, the mobile station device 1 and the base station device 3 in the above-described embodiments may be partially or entirely achieved typically as an LSI, which is an integrated circuit. The functional blocks of the mobile station device 1 and the base station device 3 may be individually made into chips or may be partially or entirely integrated into chips. Still further, the methodology of making an integrated circuit can be achieved not only with an LSI but also with a dedicated circuit or a general-purpose processor. Still further, when a technique of making an integrated circuit emerges to replace the LSI with advancement of semiconductor technology, an integrated circuit by the technique can also be used.

In the foregoing, while the embodiments of the present invention have been described in detail with reference to the drawing, a specific structure is not restricted to these embodiments, and designs and the like within a range not deviating from the gist of the present invention are included in the scope of claims for patent.

### REFERENCE SIGNS LIST

1, UE1, UE1-1, UE1-2, 1-p, 1-q mobile station device
3, eNB3 base station device
101 antenna
103 reception processing unit
105 reference signal demultiplexing unit
107 reception quality measuring unit
109 transmission method determining unit
111 control information generating unit
113 control information transmitting unit
115 transmission scheme selecting unit
117, 117-1 to 117-m coding unit
118, 118-1 to 118-n modulating unit
119 frequency mapping unit
121, 121-1 to 121-m interleaver unit
123 reference signal multiplexing unit
125 IFFT unit
127 transmission processing unit
201 data demultiplexing unit
203, 203-1, 203-2 layer assignment selecting unit
205 first layer assigning unit
207 second layer assigning unit
301 antenna
303 reception processing unit
305 FFT unit
307 reference signal demultiplexing unit
309 channel estimating unit
311 control information demultiplexing unit
313 signal detecting unit
315 control information extracting unit
317 de-mapping unit
401 channel compensating unit
403 first layer demodulating unit
405 second layer demodulating unit
407 demodulated signal extracting unit
409 de-interleaver unit
411 decoding unit
501-1, 501-2 soft canceller unit
503 replica generating unit
505-1, 505-2 interleaver unit
507-1, 5-7-2 decoding unit
509-1, 509-2 de-interleaver unit
601-1, 601-2 layer assignment selecting unit
603 first replica generating unit
605 second replica generating unit
701-1, 701-2 layer assignment selecting unit
801 demodulated signal extracting unit

1. A transmitting device which performs data transmission to a plurality of receiving devices by using a plurality of symbols and a plurality of layers with different distances between signal points, the transmitting device comprising:
a layer assigning unit which assigns data to be transmitted to a first receiving device to a first layer in a predetermined symbol of the plurality of symbols and assigns data to be transmitted to a second receiving device different from the first receiving device to the first layer in remaining symbols; and
a transmitting unit which transmits each of the data assigned to the first layer to the first receiving device and the second receiving device.

2. The transmitting device according to claim 1,
wherein the layer assigning unit assigns the data to be transmitted to the first receiving device to the first layer in the predetermined symbol of the plurality of symbols and assigns the data to be transmitted to the second receiving device to a second layer different from the first layer, and
the transmitting unit transmits the data assigned to the first layer to the first receiving device and transmits the data assigned to the second layer to the second receiving device.

3. The transmitting device according to claim 1,
wherein the layer assigning unit determines the predetermined symbol based on a table or a definition equation configured in advance.

4. The transmitting device according to claim 1,
wherein the layer assigning unit sets a number of predetermined symbols at an integer closest to M/N, where N is a positive integer representing a number of the layers and M is a positive integer representing a number of the plurality of symbols.

5. The transmitting device according to claim 1,
wherein the layer assigning unit determines a number of the predetermined symbols in accordance with reception quality.

6. The transmitting device according to claim 1,
wherein a coding rate is determined in accordance with the number of the predetermined symbols.

7. The transmitting device according to claim 1,
wherein the first layer is a layer with most favorable error rate performance.

8. The transmitting device according to claim 1 which assigns the plurality of symbols to a sub-carrier configuring an orthogonal frequency division multiplexing (OFDM) signal,
wherein the layer assigning unit assigns the data to be transmitted to the first receiving device to the first layer in a predetermined OFDM symbol and assigns the data to a layer different from the first layer in another OFDM symbol.

9. A receiving device which receives data transmitted from the transmitting device according to claim 1 by using a plurality of symbols and a plurality of layers with different distances between signal points, the receiving device comprising:
a layer demodulating unit which demodulates data assigned to the plurality of layers for each of the layers; and
an extracting unit which extracts the data from the signal demodulated for each of the layers.

10. A transmitting method for performing data transmission to a plurality of receiving devices by using a plurality of symbols and a plurality of layers with different distances between signal points, the method comprising at least:
a step of assigning data to be transmitted to a first receiving device to a first layer in a predetermined symbol of the plurality of symbols and assigning data to be transmitted to a second receiving device different from the first receiving device to the first layer in remaining symbols; and
a step of transmitting each of the data assigned to the first layer to the first receiving device and the second receiving device.

11-12. (canceled)
